(19) United States
(12) Patent Application Publication
(10) Pub. No.: US 2026/0072271 A1
(43) Pub. Date: Mar. 12, 2026

(54) DISPLAY DEVICE, HEAD-UP DISPLAY SYSTEM, AND AUTOMOBILE

(71) Applicant: WUHAN CHINA STAR OPTOELECTRONICS TECHNOLOGY CO., LTD., Wuhan (CN)

(72) Inventors: Fancheng LIU, Wuhan (CN); Yantao GUAN, Wuhan (CN); Guowei ZHA, Wuhan (CN)

(73) Assignee: WUHAN CHINA STAR OPTOELECTRONICS TECHNOLOGY CO., LTD., Wuhan (CN)

(21) Appl. No.: 19/026,528

(22) Filed: Jan. 17, 2025

Related U.S. Application Data
(63) Continuation of application No. PCT/CN2024/129292, filed on Nov. 1, 2024.

(30) Foreign Application Priority Data
Sep. 12, 2024 (CN) 202411283108.6

(51) Int. Cl. G02B 27/01; G02B 3/00

(52) U.S. Cl. CPC G02B 27/0101; G02B 3/0037; G02B 3/0043

(57) ABSTRACT

The present disclosure provides a display device, a head-up display system, and an automobile. The display device includes a backplane and a lens assembly, the backplane includes a plurality of pixels, the lens assembly includes a plurality of lenses, and the lenses are positioned over the pixels. A first spacing between two adjacent pixels in a first direction is less than a second spacing between two adjacent pixels in a second direction, and the second spacing is less than or equal to 1.5 times the first spacing. A third spacing between two adjacent lenses in the first direction is less than a fourth spacing between two adjacent lenses in the second direction. The present disclosure can improve the brightness of the display device.

### CROSS-REFERENCE TO RELATED APPLICATIONS

This application is a continuation of International Application No. PCT/CN2024/129292, filed on Nov. 1, 2024, which claims priority to and the benefit of Chinese Patent Application No. 202411283108.6, filed on Sep. 12, 2024. The disclosures of the aforementioned applications are incorporated herein by reference in their entireties.

### TECHNICAL FIELD

The present disclosure relates to the field of display technology, and more particularly, to a display device, a head-up display system, and an automobile.

### BACKGROUND

Currently, Augmented Reality Head-Up Displays (AR-HUDs) are gradually becoming an important feature in high-end vehicles.

In practice, the inventor(s) has found that:

AR-HUD systems need to maintain clarity and visibility under various lighting conditions, especially in bright environments. However, the brightness of traditional display devices is not sufficient to meet this requirement, leading to blurred or difficult-to-recognize display content in situations such as direct sunlight. Therefore, enhancing the brightness of display devices has become a key issue in the development of AR-HUD technology.

Furthermore, AR-HUD systems require display devices to have different viewing angles at different positions, while traditional display devices have the same viewing angle characteristics at different positions, thus failing to meet the special needs of AR-HUDs and affecting the accurate presentation of information and the viewing experience.

Therefore, it is necessary to propose a new technical solution to address the above technical issues.

### SUMMARY

Embodiments of the present disclosure provide a display device, a head-up display system, and an automobile to improve brightness of the display device.

An embodiment of the present disclosure provides a display device including a backplane on which a plurality of pixels are provided; and a lens assembly disposed on the backplane, the lens assembly including a plurality of lenses, each lens being positioned over a corresponding one of the pixels; where in a top view of the display device, a first spacing c1 between two adjacent ones of the pixels in a first direction is less than a second spacing d1 between two adjacent ones of the pixels in a second direction, and the second spacing d1 is less than or equal to 1.5 times the first spacing c1; in the top view of the display device, a third spacing c2 between two adjacent ones of the lenses in the first direction is less than a fourth spacing d2 between two adjacent ones of the lenses in the second direction.

An embodiment of the present disclosure further provides a head-up display system including an optical assembly and the display device described above; where the optical assembly is configured to magnify and output a picture displayed by the display device, and the optical assembly has a magnification of M in the first direction and a magnification of M/(d1/c1) in the second direction for the picture displayed by the display device.

An embodiment of the present disclosure further provides an automobile including a head-up display system, the head-up display system including an optical assembly and the display device described above; where the optical assembly is configured to magnify and output a picture displayed by the display device, and the optical assembly has a magnification of M in the first direction and a magnification of M/(d1/c1) in the second direction for the picture displayed by the display device.

### Beneficial Effect

In the technical solution of the present disclosure, a lens assembly is provided on a backplane of a display device, the lens assembly includes a plurality of lenses, each lens being positioned over a corresponding pixel, a first spacing between two adjacent pixels in a first direction (e.g., a horizontal direction) is less than a second spacing between two adjacent pixels in a second direction (e.g., a vertical direction), and the second spacing is less than or equal to 1.5 times the first spacing; at the same time, a third spacing between the two adjacent lenses in the first direction is less than a fourth spacing between the two adjacent lenses in the second direction. This allows for an increase in the pixel and lens spacing in the second direction of the display device. By increasing the size of the lenses in the second direction, more light can be collected and focused, thereby increasing the brightness of the display device. In particular, increasing the size of the lenses in the vertical direction can increase the brightness without affecting the display quality, solving the problem of insufficient brightness of traditional display devices in bright environments.

In addition, the technical solution of the present disclosure realizes that the display device has different viewing angle characteristics at different positions by adjusting the spacing between the pixels and the lenses at different positions. Specifically, by adjusting the difference between the third spacing and the first spacing, and the difference between the fourth spacing and the second spacing, the viewing angle of the display device at different positions can be accurately controlled, so that the display device can meet the special needs of the head-up system for different viewing angles at different positions, for example, the display device can have a wider viewing angle in the horizontal direction and a narrower viewing angle in the vertical direction, which matches the actual viewing needs of the driver.

The technical solution of the present disclosure can also divide the display device into a plurality of areas (e.g., upper left, upper right, lower left, and lower right) as required, and separately adjust the viewing angle for each area, thereby more accurately meeting the viewing angle requirements at different positions.

### BRIEF DESCRIPTION OF THE DRAWINGS

FIG. 1 is a schematic diagram of a first embodiment of a display device according to the present disclosure.

FIG. 2 is a schematic diagram of a second embodiment of a display device according to the present disclosure.

FIG. 3 is a schematic diagram of a pixel cell and a corresponding lens position offset of the display device shown in FIG. 2.

FIG. 4 is a schematic diagram of viewing angles of the display device shown in FIG. 2 at different positions.

FIG. 5 is a schematic diagram of viewing angles of the display device shown in FIG. 2 at different positions in a first direction.

FIG. 6 is a schematic diagram of the viewing angle of the display device shown in FIG. 2 at different positions in a second direction.

FIG. 7 is a schematic diagram of the relationship between viewing angles and brightness of the display device shown in FIG. 2 at different positions in a first direction.

FIG. 8 is a schematic diagram of the relationship between viewing angles and brightness of the display device shown in FIG. 2 at different positions in a second direction.

FIG. 9 is a schematic diagram of a third embodiment of a display device according to the present disclosure.

### DETAILED DESCRIPTION

The following provides a detailed description of the specific implementations of the present disclosure in conjunction with the accompanying drawings.

The terms “first,” “second,” and similar terms do not denote any order, quantity, or importance, but are used to distinguish different technical features. The term “a plurality of” and similar terms indicate two or more, unless otherwise specifically limited.

The embodiments of the present disclosure may be combined with each other.

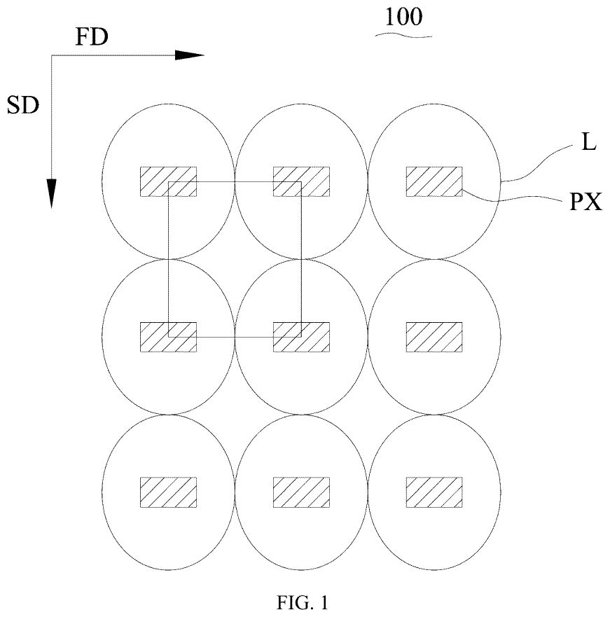

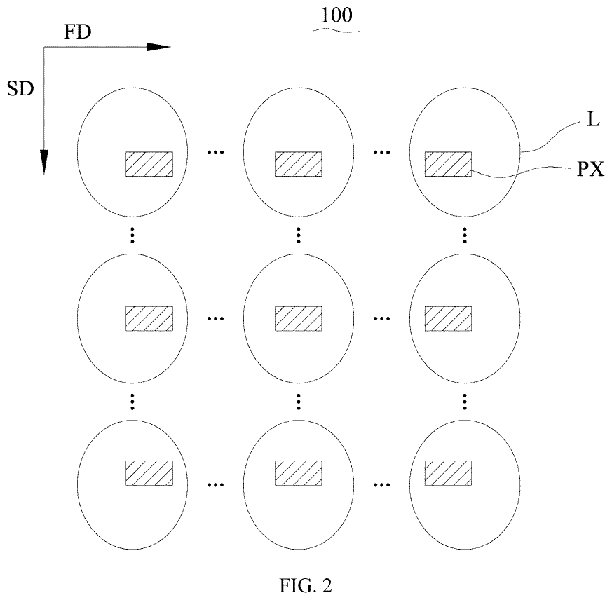

As shown in FIGS. 1 and 2, an embodiment of the present disclosure provides a display device 100 including a backplane on which a plurality of pixels PX, which may be OLED light-emitting elements, Mini-LED light-emitting elements, or Micro-LED light-emitting elements, are provided, and a lens assembly.

The lens assembly is provided on the backplane, the lens assembly including a plurality of lenses L, each of which is positioned over a corresponding one of the pixels PX. Specifically, the lens assembly includes a plurality of lenses L equal to the number of pixels PX on the backplane. The position of each lens L corresponds to the position of the corresponding pixel PX. For example, the lens L at least partially overlaps with the pixel PX, that is, the center of the lens L coincides with the center of the pixel PX, or the lens L is positioned to be roughly within the same spatial range as the pixel PX to ensure that the lens L can effectively focus the light emitted by the pixel PX. The material of lens L can be, for example, a high refractive index polymer material, such as polycarbonate (PC) or cyclic olefin copolymer (COC).

In a top view of the display device 100, a first spacing c1 between two adjacent pixels PX in a first direction FD is less than a second spacing d1 between two adjacent pixels PX in a second direction SD, and d1 is less than or equal to 1.5 times c1. The first direction FD is the horizontal direction, the second direction SD is the vertical direction, and vice versa.

In the top view of the display device 100, a third spacing c2 between two adjacent lenses L in the first direction FD is less than a fourth spacing d2 between two adjacent lenses L in the second direction SD.

The pixels PX of conventional display devices are generally arranged equidistantly, but this arrangement is difficult to meet the special needs of the AR-HUD system. The pixels PX of the display device 100 of the embodiment of the present disclosure is arranged non-equidistantly, specifically such that the first spacing c1 between two adjacent pixels PX in the first direction FD is less than the second spacing d1 between two adjacent pixels PX in the second direction SD, and d1 is less than or equal to 1.5 times c1.

By increasing d1 and limiting d1 not to exceed 1.5 times c1, the display effect in the vertical direction can be ensured while the lens L has a larger size in the vertical direction, so that the viewing angle can be narrowed in the vertical direction and the brightness of the display device 100 can be improved.

Similar to the pixels PX, the third spacing c2 between two adjacent lenses L in the first direction FD is less than the fourth spacing d2 between two adjacent lenses L in the second direction SD.

The lens L is a semi-ellipsoidal lens, and in the top view of the display device 100, the length of a lens L in the second direction SD is greater than the length of the lens L in the first direction FD. Semi-ellipsoidal lenses help to achieve greater light-gathering effect in the vertical direction. The bottom surface of the lens L (the surface adjacent to the backplane) is planar, and the top surface of the lens L (the surface away from the backplane) is curved. The thickness of the lens L gradually decreases from the center of the lens L to the edge of the lens L. The lens L has different curvatures in the first direction FD and the second direction SD, in particular, the curvature of the lens L in the second direction SD is less than the curvature in the first direction FD.

In the top view of the display device 100, the length of the lens L in the second direction SD is greater than the length in the first direction FD. By adjusting the ratio of the long and short axes of the semi-ellipsoidal lens L, the viewing angle distribution of the display device 100 in the horizontal and vertical directions can be adjusted to improve the brightness of the display device 100.

At the center of the display device 100, the center of the lens L is aligned with the center of the pixel PX. From the center towards the edge, the relative position of the lens L with respect to the pixel PX is gradually shifted to realize viewing angle control.

In the first direction FD of the display device 100, the first spacing c1 between two adjacent pixels PX is smaller; while in the second direction SD, the second spacing d1 between two adjacent pixels PX is greater than c1, but the value of d1 is less than or equal to 1.5 times the value of c1. Correspondingly, in the top view of the display device 100, the third spacing c2 between two adjacent lenses L in the first direction FD is less than the fourth spacing d2 between two adjacent lenses L in the second direction SD. Therefore, it allows the lens L to have a larger size in the vertical direction, thereby better focusing the light emitted by the pixels PX and enhancing the brightness of the display device 100.

The third spacing c2 between two adjacent lenses L in the first direction FD is greater than or equal to the first spacing c1 between two adjacent pixels PX in the first direction FD, and the fourth spacing d2 between two adjacent lenses L in the second direction SD is greater than the second spacing d1 between two adjacent pixels PX in the second direction SD.

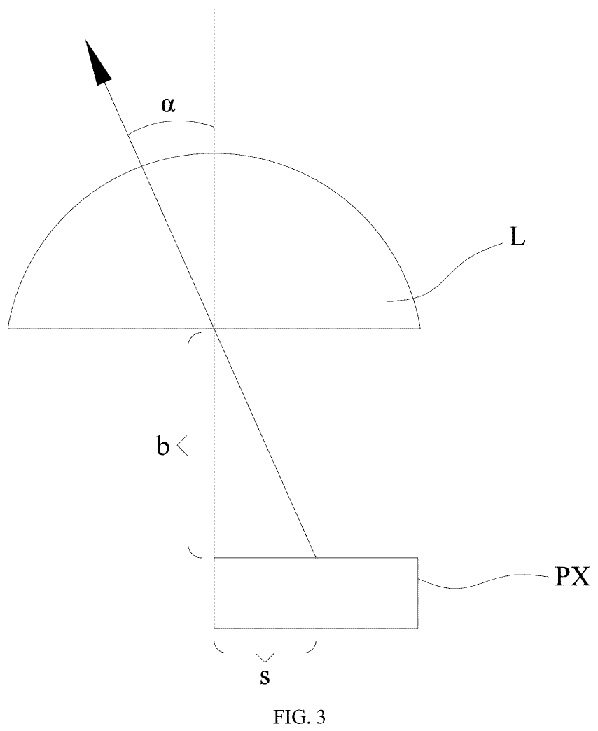

As shown in FIG. 3, in the first direction FD, at the edge of the display device 100, the offset distance of the center of the lens L (a center of the semi-ellipsoid) with respect to the center of the pixel PX is b*tan α; in the second direction SD, at the edge of the display device 100, the offset distance of the center of the lens L (the center of the semi-ellipsoid) with respect to the center of the pixel PX is b*tan γ.

As shown in FIG. 1, under a condition that the third spacing c2 is equal to the first spacing c1, the difference between the third spacing c2 and the first spacing c1 is 0. Alternatively, as shown in FIG. 2, under a condition that the third spacing c2 is greater than the first spacing c1, the difference between the third spacing c2 and the first spacing c1 is (b*tan α)/(p/2).

As shown in FIGS. 1 and 2, the difference between the fourth spacing d2 and the second spacing d1 is (b*tan γ)/(q/2);

Where b is the distance between the lens L and the pixel PX in the direction perpendicular to the display device 100, α is the viewing angle at the edge of the display device 100 in the first direction FD, p is the resolution of the display area of the display device 100 in the first direction FD, γ is the viewing angle at the edge of the display device 100 in the second direction SD, and q is the resolution of the display area of the display device 100 in the second direction SD.

If the third spacing c2 is greater than the first spacing c1, c1=c2−(b*tan α)/(p/2);

$$d 1 = d 2 - ( b * tan γ ) / ( q / 2 ) ;$$

Where c2=l/p, d2=w/q, and l is the length value of the display area of the display device 100 in the first direction FD, and w is the length value of the display area of the display device 100 in the second direction SD.

That is, the first spacing between two adjacent pixels PX in the first direction FD is c1=c2−(b*tan α)/(p/2), and the second spacing between two adjacent pixels PX in the second direction SD is d1=d2−(b*tan γ)/(q/2).

In the present embodiment, the spacing c2 and d2 of the two adjacent lenses L remain unchanged, and the spacing c1 and the spacing d1 of the two adjacent pixels PX are reduced (retracted) with respect to the spacing c2 and the spacing d2 of the lenses L.

If the third spacing c2 is greater than the first spacing c1, c2=c1+(b*tan α)/(p/2);

$$d 2 = d 1 + ( b * tan γ ) / ( q / 2 ) ;$$

Where c1=l/p, d1=w/q, and l is the length value of the display area of the display device 100 in the first direction FD, and w is the length value of the display area of the display device 100 in the second direction SD.

That is, the third spacing between two adjacent lenses L in the first direction FD is c2=c1+(b*tan α)/(p/2), and the fourth spacing between two adjacent lenses L in the second direction SD is d2=d1+(b*tan γ)/(q/2).

In the present embodiment, the spacing c1 and the spacing d1 of the two adjacent pixels PX remain unchanged, and the spacing c2 and the spacing d2 of the two adjacent lenses L are increased (outwardly expanded) with respect to the spacing c1 and the spacing d1 of the pixels PX. By adjusting the spacing(s) of the lens L, the viewing angle is differentiated without adjusting the spacing(s) of the pixels PX.

In the first direction FD, the difference between the spacing between the m-th pixel PX and the (m+1)-th pixel PX and the spacing between the (m+1)-th pixel PX and the (m+2)-th pixel PX is 0, and the difference between the spacing between the m-th lens L and the (m+1)-th lens L and the spacing between the (m+1)-th lens L and the (m+2)-th lens L is 0, wherein m is greater than or equal to 1 and less than p/2.

In the second direction SD, the difference between the spacing between the n-th pixel PX and the (n+1)-th pixel PX and the spacing between the (n+1)-th pixel PX and the (n+2)-th pixel PX is 0, and the difference between the spacing between the n-th lens L and the (n+1)-th lens L and the spacing between the (n+1)-th lens L and the (n+2)-th lens L is 0, wherein n is greater than or equal to 1 and less than q/2.

In the top view of the display device 100, in the first direction FD, the offset value between the center of the lens L located in the center of the display device 100 and the center of the pixel PX located in the center of the display device 100 is 0, and in the second direction SD, the offset value between the center of the lens L located in the center of the display device 100 and the center of the pixel PX located in the center of the display device 100 is b*tan β, where b is the distance between the lens L and the pixel PX in the direction perpendicular to the display device 100, and β is the viewing angle at the center of the display device 100 in the second direction SD.

By ensuring that the pixel PX and the lens L located at the center of the display device 100 are aligned (not offset) in the first direction FD, it is possible to realize that horizontal viewing angles at different positions of the display device 100 are different.

By ensuring that the pixel PX located at the center of the display device 100 is upwardly or downwardly offset from the lens L located at the center of the display device 100 by b*tan β in the vertical direction, that is, the lens L located at the center of the lens assembly is upwardly or downwardly offset from the pixel PX located at the center of the display device 100 by b*tan β, it is possible to achieve different vertical viewing angles at different positions of the display device 100.

In the top view of the display device 100, the offset value between the center of the m-th pixel PX and the center of the m-th lens L is (m*b*tan α)/(p/2) in the first direction FD, and the offset value between the center of the n-th pixel PX and the center of the n-th lens L is (n*b*tan γ)/(q/2) in the second direction SD;

Where m is greater than or equal to 1 and less than p/2 and n is greater than or equal to 1 and less than q/2.

For some special cases, for example, the left and right viewing angles are asymmetric or the upper and lower viewing angles are asymmetric, the display device 100 is divided into four areas: an upper left area, an upper right area, a lower left area, and a lower right area. The spacing of the pixels PX or the spacing of the lens L of each area is different from the spacing of the pixels PX or the spacing of the lens L of other areas, and the spacing of the pixels PX or the spacing of the lens L of each area is independently set to meet the specific viewing angle requirements of the area.

For each area, the adjustment values of the spacing of the pixel PX and the spacing of the lens L are calculated from the horizontal and vertical viewing angles at the edges of the area.

As shown in FIG. 9, the display device 100 includes at least four areas including an upper left area, an upper right area, a lower left area, and a lower right area.

For the upper left area, the difference between the third spacing c2 between two adjacent lenses L in the first direction FD and the first spacing c1 between two adjacent pixels PX in the first direction FD is (b*tan α1)/(p/2), and the difference between the fourth spacing d2 between two adjacent lenses L in the second direction SD and the second spacing d1 between two adjacent pixels PX in the second direction SD is (b*tan β1)/(q/2).

For the upper right area, the difference between the third spacing c2 between two adjacent lenses L in the first direction FD and the first spacing c1 between two adjacent pixels PX in the first direction FD is (b*tan α2)/(p/2), and the difference between the fourth spacing d2 between two adjacent lenses L in the second direction SD and the second spacing d1 between two adjacent pixels PX in the second direction SD is (b*tan β2)/(q/2).

For the lower left area, the difference between the third spacing c2 between two adjacent lenses L in the first direction FD and the first spacing c1 between two adjacent pixels PX in the first direction FD is (b*tan α3)/(p/2), and the difference between the fourth spacing d2 between two adjacent lenses L in the second direction SD and the second spacing d1 between two adjacent pixels PX in the second direction SD is (b*tan β3)/(q/2).

For the lower right area, the difference between the third spacing c2 between two adjacent lenses L in the first direction FD and the first spacing c1 between two adjacent pixels PX in the first direction FD is (b*tan α4)/(p/2), and the difference between the fourth spacing d2 between two adjacent lenses L in the second direction SD and the second spacing d1 between two adjacent pixels PX in the second direction SD is d1 (b*tan β4)/(q/2).

Where α1, α2, α3, and α4 are the viewing angles at the edges of the four areas of the display device 100 in the first direction FD, β1, β2, β3, and β4 are the viewing angles at the edges of the four areas of the display device 100 in the second direction SD, b is the distance between the lens L and the pixel PX in the direction perpendicular to the display device 100, p is the resolution of the display device 100 in the first direction FD, and q is the resolution of the display device 100 in the second direction SD.

The viewing angle width of the display device 100 in the first direction FD is greater than the viewing angle width in the second direction SD.

The viewing angle width (viewing angle range) of the display device 100 in the first direction FD (horizontal direction) is about 30°, and the viewing angle width (viewing angle range) in the second direction SD (vertical direction) is about 18°.

As an improvement, the surface of the lens L is an aspheric surface, and specifically, the surface of the lens L is a rotating parabolic surface or a rotating hyperboloid surface to achieve a better light focusing effect.

As an improvement, the surface of the lens L is provided with a microstructure portion which is a Fresnel lens or a micro-prism. The microstructure portion can control the exit angle of the light and further improve the brightness of the display device 100. For example, by forming a periodic concentric annular structure portion on the surface of the lens L by the etching process, the effect of the Fresnel lens can be achieved, and the light focusing effect can be ensured.

In order for the display device 100 to have different viewing angles at different positions, the lens L includes a multilayer structure, for example, the lens L includes a main lens layer and an array of microlenses above the main lens layer. Such dual-layer lens structure enables finer light control, which is beneficial for realizing a more diverse range of viewing angles.

In particular, the primary lens layer (the first layer of lenses) is configured to achieve light focusing, while the microlens array (the second layer of lenses) is configured to fine-tune the light exit angle. The refractive indices of the materials of the two layers of lenses are different to achieve a better optical effect. For example, the first layer of lenses may use a high refractive index material such as silicon nitride, while the second layer of microlenses may use a relatively low refractive index material such as silicon dioxide.

As an improvement, the surface of the lens L or the surface of the backplane is provided with a grating on a micron scale. For example, the grating is a two-dimensional grating having a larger period in the first direction FD and a smaller period in the second direction SD. By adjusting the period(s) of the grating, selective diffraction of light in different directions can be achieved, thereby controlling the viewing angle.

As an improvement, the refractive index within the lens L exhibits an axial gradient (forming a refractive index gradient along the thickness direction of the lens L to reduce spherical aberration) and/or a radial gradient (forming a refractive index gradient along the radius direction of the lens L to achieve an asymmetric viewing angle). Specifically, gradient refractive index materials are used to manufacture the lens L, creating a refractive index gradient within the lens L.

The embodiment of the present disclosure increases the spacing of the pixels PX in the second direction SD and the size of the lenses L in the second direction SD (the shape of the lens L is semi-ellipsoidal, and the spacing of the lens L in the second direction SD is greater than the spacing in the first direction FD), thereby increasing the area difference between the lens L and the pixel PX, i.e., a light-emitting element (the area of the pixel PX remains unchanged, while the area of the lens L increases). This reduces the divergence and loss of light, thereby enhancing the display brightness of the display device 100 in the second direction SD.

Furthermore, the embodiment of the present disclosure controls the pixel PX and the lens L to have different relative positional offsets at different positions of the display device 100. As a result, the lenses L at different positions of the display device 100 have different narrowing or diverging effects on the light from the pixel PX. This allows the display device 100 to have different viewing angles at different positions, meeting the complicated viewing angle requirements of the AR-HUD system.

In the technical solution of the present disclosure, a lens assembly is provided on a backplane of a display device 100, the lens assembly includes a plurality of lenses L, each lens L is positioned over a corresponding pixel PX, a first spacing c1 between two adjacent pixels PX in a first direction FD (e.g., a horizontal direction) is less than a second spacing d1 between two adjacent pixels PX in a second direction SD (e.g., a vertical direction), and the second spacing d1 is less than or equal to 1.5 times the first spacing c1; at the same time, the third spacing c2 between the two adjacent lenses L in the first direction FD is less than the fourth spacing d2 between the two adjacent lenses L in the second direction SD, so that the pixel PX and the lens L spacing in the second direction SD of the display device 100 can be increased. Since the size of the lens L in the second direction SD is increased, more light can be collected and focused, thereby increasing the brightness of the display device 100. In particular, increasing the size of the lens L in the vertical direction can increase the brightness without affecting the display quality, thereby solving the problem of insufficient brightness of traditional display devices in bright environments.

In addition, the technical solution of the present disclosure realizes that the display device 100 has different viewing angle characteristics at different positions by adjusting the spacing between the pixels PX and the lenses L at different positions. Specifically, by adjusting the difference between the third spacing c2 and the first spacing c1 and the difference between the fourth spacing d2 and the second spacing d1, the viewing angle of the display device 100 at different positions can be accurately controlled, so that the display device 100 can meet the special needs of the head-up system for different viewing angles at different positions. For example, the display device 100 can have a wider viewing angle in the horizontal direction and a narrower viewing angle in the vertical direction, which matches the actual viewing needs of the driver.

The technical solution of the present disclosure may further divide the display device 100 into a plurality of areas (e.g., upper left, upper right, lower left, and lower right) as required, and separately adjust the viewing angle of each area, thereby more accurately meeting the viewing angle requirements of different positions.

As shown in FIG. 1, in order to improve the brightness of the display device 100 in the AR-HUD system so that the displayed image is clearly visible in bright environments, the technical solution of the embodiment of the present disclosure is as follows:

The display device 100 is an organic light-emitting diode display device, a mini light-emitting diode display device, or a miniature light-emitting diode display device, and the pixel PX is an organic light-emitting diode light-emitting element, a mini light-emitting diode light-emitting element, or a miniature light-emitting diode light-emitting element.

The backplane is provided with a lens array including lenses L in a number equal to that of the pixels PX of the backplane, with each lens L positioned to correspond to a pixel PX. The positional correspondence includes the center of the lens L coinciding with the center of the pixel PX, as well as the lens L and the pixel PX being roughly within the same spatial range. For example, the pixel PX is located within the coverage area of the lens L, or the lens L is within the coverage area of the pixel PX.

The spacing of the pixels PX of the display device 100 in the first direction FD and the spacing in the second direction SD are different, and the spacing of the lens L in the first direction FD and the spacing in the second direction SD are also different. Under a condition that the size of the display device 100 is unchanged, the resolution of the display device 100 in the first direction FD is kept unchanged, and the resolution of the display device 100 in the second direction SD is reduced (that is, the number of pixels PX of the display device 100 in the second direction SD is reduced, and the spacing of the pixels PX of the display device 100 in the second direction SD is increased). Similarly, the number of the lenses L in the second direction SD is reduced, thereby increasing the size (spacing) of the lenses L in the second direction SD and increasing the brightness. The lens L is semi-ellipsoidal, that is, in the top view of the display device 100, the length of the lens L in the second direction SD is greater than the length of the lens L in the first direction FD. The spacing of the lenses L in the second direction SD refers to the distance of the center points of the two adjacent lenses L in the second direction SD. In the present embodiment, the center point of the lens L coincides with the center point of the pixel PX.

Since the viewing angle demand of the user for the display device 100 in the second direction SD is narrow, and the viewing angle demand in the first direction FD is slightly wider, the present solution increases the width (length) of the lens L in the second direction SD, so that the difference between the area of the lens L and the area of the pixel PX in the second direction SD becomes larger, thereby the brightness of the display device 100 can be improved.

It is assumed that in the display device 100, the pixels PX and lenses L originally have the same spacing c in both the first direction FD and the second direction SD. The embodiment of the present disclosure narrows the viewing angle in the second direction SD by increasing the spacing between the pixels PX and the spacing between the lenses L in the second direction SD.

As shown in FIG. 2, in order to realize that the display device 100 in the AR-HUD system has different viewing angles at different positions, the technical solution of the embodiment of the present disclosure changes the spacing of the pixels PX or the spacing of the lenses L on the basis of the above technical solution, as follows:

Based on the distance between the pixel PX (light source) and the lens L in the direction perpendicular to the display device 100 and the viewing angle required by the display device 100 at this position, the offset spacing of the center of the lens L (a center of the semi-ellipsoid) relative to the center of the pixel PX is calculated. As shown in FIG. 3, if the viewing angle required for this position is α and the spacing between the center of the lens L (the center of the semi-ellipsoid) and the pixel PX (light source) in the direction perpendicular to the display device 100 is b, then the offset spacing between the two in the second direction SD is equal to b*tan α.

The embodiment of the present disclosure compensates for the offset of the viewing angle based on the differentiation of the spacing of the pixels PX and the spacing of the lenses L, serving both to enhance brightness and to alter the viewing angle.

Based on the above-described technical solution of the embodiment of the present disclosure (where the spacing of the pixels PX of the display device 100 in the first direction FD is c, the spacing of the pixels PX in the second direction SD is d, and the spacing of the lenses L in the first direction FD is c, and the spacing of the lenses L in the second direction SD is d), the spacing of the pixels PX is adjusted while the spacing of the lenses L remains unchanged.

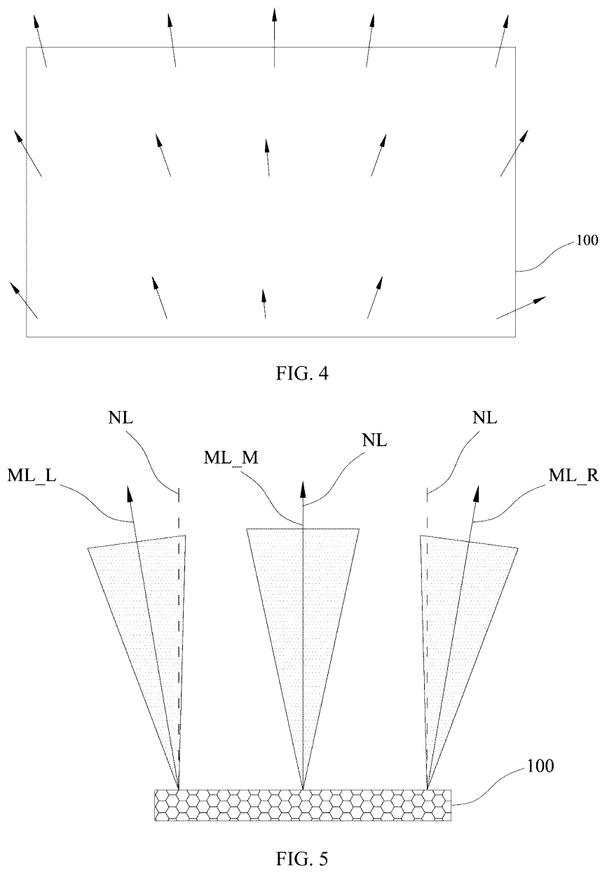

In the first direction FD, assuming that the viewing angle at the edge of the display device 100 is α and the distance between the lens L and the pixel PX (light source) in the direction perpendicular to the display device 100 is b, then the offset distance of the pixel PX at the edge of the display device 100 in the second direction SD is b*tan α. The first direction FD resolution of the display device 100 is p, and the second direction SD resolution of the display device 100 is adjusted to q, that is, the display device 100 includes p pixels PX in the first direction FD and q pixels PX in the second direction SD. The viewing angle at the center of the display device 100 in the first direction FD is less than or equal to 19°, the viewing angle at the left edge of the display device in the first direction FD is less than or equal to 23°, and the viewing angle at the right edge of the display device 100 in the first direction FD is less than or equal to 20°. The center line ML M of the viewing angle at the center point of the display device 100 is parallel to the normal line NL of the display device 100 (the included angle is 0°), the center line ML_L of the viewing angle at the left edge of the display device 100 in the first direction FD forms an angle of 24° with the normal line NL, and the center line ML_R of the viewing angle at the right edge of the display device 100 in the first direction FD forms an angle of 20° with the normal line NL, as shown in FIG. 5.

Using the center of the display device 100 as the dividing point, in the first direction FD, the number of pixels PX on either side of the dividing point is p/2. On either side of the dividing point, the difference in the offset distance between two pixels PX is (b*tan α)/(p/2).

The spacing of the pixels PX of the display device 100 in the first direction FD is c1=c−(b*tan α)/(p/2), c=c2. By ensuring that the pixel PX and the lens L located at the center point of the display device 100 are aligned and not offset in the first direction FD, it is ensured that the viewing angles of the display device 100 in the first direction FD are different from each other in different positions, thereby meeting the requirements for the viewing angles. In the formula c1=c2−(b*tan α)/(p/2), the minus sign indicates that the spacing c1 of the pixel PX is reduced with respect to the original spacing c (c2), that is, the position of the lens L is fixed, and the pixel PX is retracted with respect to the lens L.

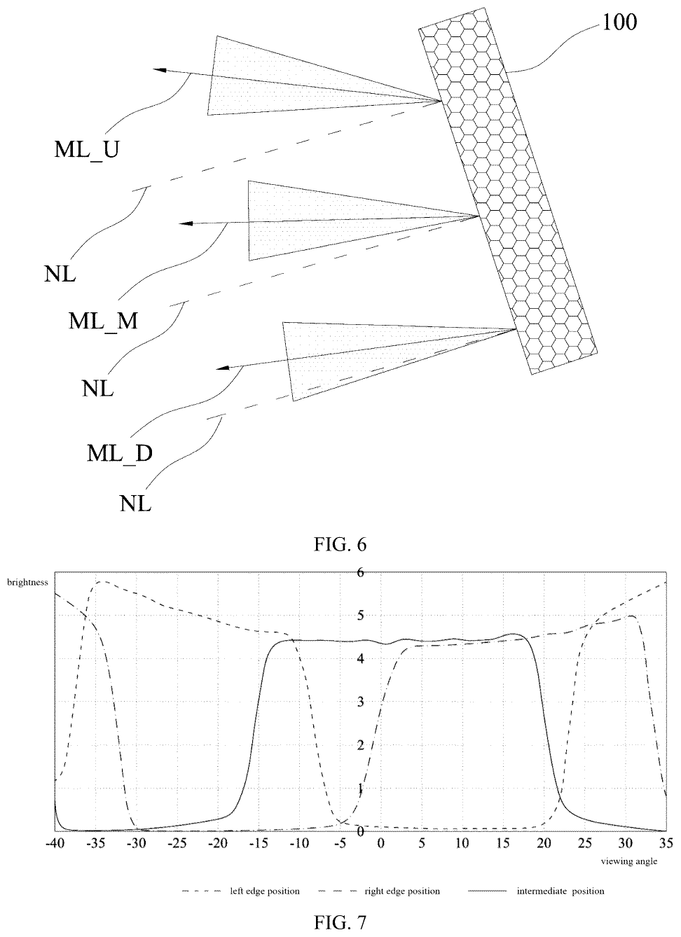

In the second direction SD, the viewing angle at the center of the display device 100 in the second direction SD is shifted, that is, the center line of the viewing angle at the center of the display device 100 in the second direction SD and the normal line of the display device 100 form an angle β of more than 0 degrees. The viewing angle at the center of the display device 100 in the second direction SD is less than or equal to 5°, the viewing angle at the upper edge of the display device 100 in the second direction SD is less than or equal to 5°, and the viewing angle at the lower edge of the display device 100 in the second direction SD is less than or equal to 7°. The centerline ML M of the viewing angle at the center point of the display device 100 forms an angle of 17° with the normal line NL of the display device 100. The centerline ML_U of the viewing angle at the upper edge of the display device 100 in the second direction SD forms an angle of 24° with the normal line NL, and the centerline ML_D of the viewing angle at the lower edge of the display device 100 in the second direction SD forms an angle of 10° with the normal line NL, as shown in FIG. 6.

Assuming that the viewing angle at the edge of the display device 100 in the second direction SD is γ, and the viewing angle at the center of the display device 100 in the second direction SD is β, then the offset distance of the lens L at the edge of the display device 100 in the second direction SD is b*tan γ, and the offset distance of the lens L at the center of the display device 100 in the second direction SD is b*tan β. Therefore, by adjusting the spacing of the lens L in the second direction SD to d2=d+(b*tan γ)/(q/2), d=d1, and then shifting the lens L upward or downward by a distance value such as b*tan β relative to the position of the lens L at the center, we can ensure that the viewing angles at different positions in the second direction SD meet the requirements. In the formula d2=d+(b*tan γ)/(q/2), the plus sign indicates that the spacing d2 of the lens L is increased with respect to the original spacing d, that is, the position of the pixel PX is fixed, and the lens L is outwardly expanded with respect to the pixel PX.

According to the above-described technical solution, the spacing of the pixels PX in the first direction FD and the spacing of the pixels PX in the second direction SD are closely related to the edge viewing angles in their respective directions. The spacing of the lenses L in the first direction FD and the spacing of the lenses L in the second direction SD have been increased relative to the original spacing c and spacing d.

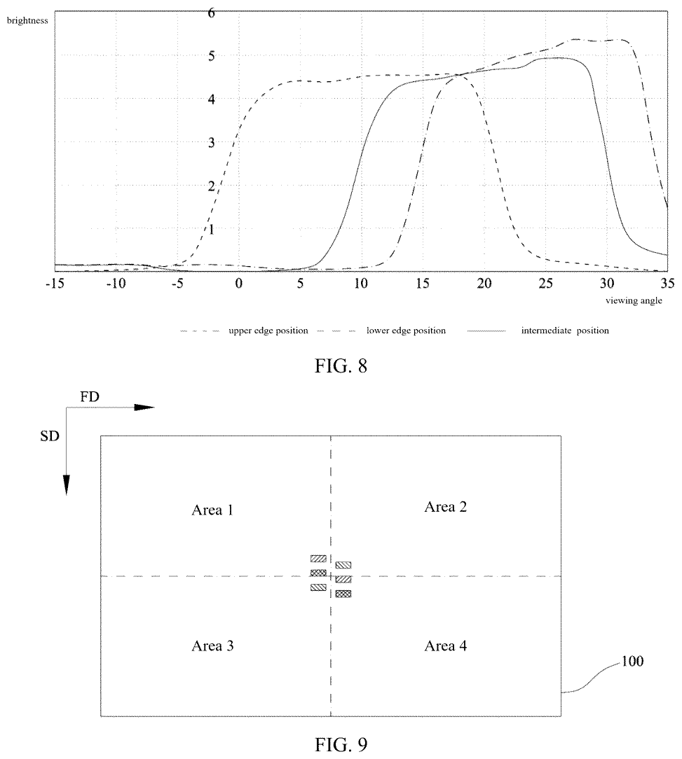

As shown in FIGS. 4, 7, and 8, the display device 100 has different viewing angles at different positions, and has different brightness at different viewing angles at a same position. FIG. 7 shows the viewing angle variation and the brightness variation at the left edge position, the right edge position and the intermediate position of the display device in the first direction FD, and FIG. 8 shows the viewing angle variation and the brightness variation at the upper edge position, the lower edge position and the intermediate position of the display device in the second direction SD.

As can be seen from FIGS. 4, 7 and 8, the viewing angle of the display device 100 in the first direction FD is wide, the viewing angle in the second direction SD is narrow. The viewing angle width in the first direction FD is about 30° while the viewing angle width requirement of the display device of the AR-HUD system in the first direction FD is only 22°. The viewing angle width in the second direction SD is about 18° while the viewing angle width requirement of the display device of the AR-HUD system in the second direction SD is only 7°. Therefore, the display device of the embodiment of the present disclosure can satisfy the viewing angle requirements of the display device of the AR-HUD system in the first direction FD and the second direction SD.

Additionally, for special requirements: the viewing angle difference between the left edge and the center is different from the viewing angle difference between the right edge and the center, which implies that the left and right viewing angles are asymmetrical. Similarly, the top and bottom viewing angles are also asymmetrical. Therefore, a differentiated design is necessary. As shown in FIG. 9, the display device 100 is divided into four areas: upper left (area 1), upper right (area 2), lower left (area 3), and lower right (area 4), with a different pixel PX spacing in each region.

In the area 1, based on the viewing angle α1 at the edge in the first direction FD and the viewing angle β1 at the edge in the second direction SD, the offset distance at the edge position in the first direction FD is calculated as b*tan α1, and the offset distance at the edge position in the second direction SD is calculated as d*tan β1. Accordingly, the spacing c1 of the pixel PX in the first direction FD in the area 1 is adjusted to c2−(b*tan α1)/(p/2), and the spacing d1 of the pixel PX in the second direction SD in the area 1 is adjusted to d2−(b*tan β1)/(q/2).

In the area 2, based on the viewing angle α2 at the edge in the first direction FD and the viewing angle β2 at the edge in the second direction SD, the offset spacing at the edge position in the first direction FD is calculated as b*tan α2, and the offset spacing at the edge position in the second direction SD is calculated as b*tan β2, the spacing c1 of the pixel PX in the first direction FD in the area 2 is adjusted to c2−(b*tan α2)/(p/2), and the spacing d1 of the pixel PX in the second direction SD in the area 2 is adjusted to d2−(b*tan β2)/(q/2).

In the area 3, based on the viewing angle α3 at the edge in the first direction FD and the viewing angle β3 at the edge in the second direction SD, the offset spacing at the edge position in the first direction FD is calculated as b*tan α3, and the offset spacing at the edge position in the second direction SD is calculated as b*tan β3, the spacing c1 of the pixel PX in the first direction FD in the area 3 is adjusted to c2−(b*tan α3)/(p/2), and the spacing d1 of the pixel PX in the second direction SD in the area 3 is adjusted to d2−(b*tan β3)/(q/2).

In the area 4, based on the viewing angle α4 at the edge in the first direction FD and the viewing angle β4 at the edge in the second direction SD, the offset spacing at the edge position in the first direction FD is calculated as b*tan α4, and the offset spacing at the edge position in the second direction SD is calculated as b*tan β4, the spacing c1 of the pixel PX in the first direction FD in the area 4 is adjusted to c2−(b*tan α4)/(p/2), and the spacing d1 of the pixel PX in the second direction SD in the area 4 is adjusted to d2−(b*tan β4)/(q/2).

Or alternatively,

In the area 1, based on the viewing angle α1 at the edge in the first direction FD and the viewing angle β1 at the edge in the second direction SD, the offset distance at the edge position in the first direction FD is calculated as b*tan α1, and the offset distance at the edge position in the second direction SD is calculated as b*tan β1. Accordingly, the spacing c2 of the lens L in the first direction FD in the area 1 is adjusted to c1+(b*tan α1)/(p/2), and the spacing d2 of the lens L in the second direction SD in the area 1 is adjusted to d1+(b*tan β1)/(q/2).

In the area 2, based on the viewing angle α2 at the edge in the first direction FD and the viewing angle β2 at the edge in the second direction SD, the offset spacing at the edge position in the first direction FD is calculated as b*tan α2, and the offset spacing at the edge position in the second direction SD is calculated as b*tan β2, the spacing c2 of the lens Lin the first direction FD in the area 2 is adjusted to c1+(b*tan α2)/(p/2), and the spacing d2 of the lens L in the second direction SD in the area 2 is adjusted to d1+(b*tan β2)/(q/2).

In the area 3, based on the viewing angle α3 at the edge in the first direction FD and the viewing angle β3 at the edge in the second direction SD, the offset spacing at the edge position in the first direction FD is calculated as b*tan α3, and the offset spacing at the edge position in the second direction SD is calculated as b*tan β3, the spacing c2 of the lens Lin the first direction FD in the area 3 is adjusted to c1+(b*tan α3)/(p/2), and the spacing d2 of the lens L in the second direction SD in the area 3 is adjusted to d1+(b*tan β3)/(q/2).

In the area 4, based on the viewing angle α4 at the edge in the first direction FD and the viewing angle β4 at the edge in the second direction SD, the offset spacing at the edge position in the first direction FD is calculated as b*tan α4, and the offset spacing at the edge position in the second direction SD is calculated as b*tan β4, the spacing c2 of the lens Lin the first direction FD in the area 4 is adjusted to c1+(b*tan α4)/(p/2), and the spacing d2 of the lens L in the second direction SD in the area 4 is adjusted to d1+(b*tan β4)/(q/2).

An embodiment of the present disclosure further provides a head-up display system including a display device and an optical assembly for magnifying and outputting a picture displayed by the display device, the optical assembly having a magnification of M in a first direction and a magnification of M/(d1/c1) in a second direction for the picture displayed by the display device.

Embodiments of the present disclosure also provide an automobile including a head-up display system.

The embodiments of the present disclosure have been described in detail above, and the contents of this specification should not be construed as limiting the scope of protection of the present disclosure.

What is claimed is:

1. A display device, wherein the display device comprises:
a backplane provided with a plurality of pixels; and
a lens assembly disposed on the backplane, the lens assembly including a plurality of lenses, each lens being positioned over a corresponding one of the pixels;
wherein in a top view of the display device, a first spacing c1 between two adjacent pixels in a first direction is less than a second spacing d1 between two adjacent pixels in a second direction, and the second spacing d1 is less than or equal to 1.5 times the first spacing c1;
in the top view of the display device, a third spacing c2 between two adjacent lenses in the first direction is less than a fourth spacing d2 between two adjacent lenses in the second direction.

2. The display device according to claim 1, wherein the third spacing c2 is greater than or equal to the first spacing c1 and the fourth spacing d2 is greater than the second spacing d1.

3. The display device according to claim 1, wherein a difference between the third spacing c2 and the first spacing c1 is (b*tan α)/(p/2), or a difference between the third spacing c2 and the first spacing c1 is 0;
a difference between the fourth spacing d2 and the second spacing d1 is (b*tan γ)/(q/2);
where b is a distance between the lens and the pixel in a direction perpendicular to the backplane, α is a viewing angle at an edge of the backplane in the first direction, p is a resolution of a display area of the display device in the first direction, γ is a viewing angle at an edge of the backplane in the second direction, and q is a resolution of a display area of the display device in the second direction.

4. The display device according to claim 3, wherein under a condition that the third spacing c2 is greater than the first spacing c1, c1=c2−(b*tan α)/(p/2);
$$d 1 = d 2 - ( b * tan γ ) / ( q / 2 ) ;$$
where c2=l/p, d2=w/q, and l is a length value of the display area of the display device in the first direction, and w is a length value of the display area of the display device in the second direction.

5. The display device according to claim 3, wherein under a condition that the third spacing c2 is greater than the first spacing c1, c2=c1+(b*tan α)/(p/2);
$$d 2 = d 1 + ( b * tan γ ) / ( q / 2 ) ;$$
where c1=l/p, d1=w/q, and l is a length value of the display area of the display device in the first direction, and w is a length value of the display area of the display device in the second direction.

6. The display device according to claim 3, wherein in the top view of the display device, an offset value between a center of an m-th pixel and a center of an m-th lens in the first direction is (m*b*tan α)/(p/2), and an offset value between a center of an n-th pixel and a center of an n-th lens in the second direction is (n*b*tan γ)/(q/2);
wherein m is greater than or equal to 1 and less than p/2 and n is greater than or equal to 1 and less than q/2.

7. The display device according to claim 1, wherein in the top view of the display device, in the first direction, an offset value between a center of the lens located at a center of the backplane and a center of the pixel located at the center of the backplane is 0, and in the second direction, an offset value between the center of the lens located at the center of the backplane and the center of the pixel located at the center of the backplane is b*tan β, wherein b is a distance between the lens and the pixel in a direction perpendicular to the backplane, and β is a viewing angle at the center of the backplane in the second direction.

8. The display device according to claim 1, wherein the backplane includes at least four areas, the at least four of the areas including an upper left area, an upper right area, a lower left area, and a lower right area;
for the upper left area, a difference between the third spacing c2 between two adjacent lenses in the first direction and the first spacing c1 between two adjacent pixels in the first direction is (b*tan α1)/(p/2), and a difference between the fourth spacing d2 between two adjacent lenses in the second direction and the second spacing d1 between two adjacent pixels in the second direction is (b*tan β1)/(q/2);
for the upper right area, a difference between the third spacing c2 between two adjacent lenses in the first direction and the first spacing c1 between two adjacent pixels in the first direction is (b*tan α2)/(p/2), and a difference between the fourth spacing d2 between two adjacent lenses in the second direction and the second spacing d1 between two adjacent pixels in the second direction is (b*tan β2)/(q/2);
for the lower left area, a difference between the third spacing c2 between two adjacent lenses in the first direction and the first spacing c1 between two adjacent pixels in the first direction is (b*tan α3)/(p/2), and a difference between the fourth spacing d2 between two adjacent lenses in the second direction and the second spacing d1 between two adjacent pixels in the second direction is (b*tan β3)/(q/2);
for the lower right area, a difference between the third spacing c2 between two adjacent lenses in the first direction and the first spacing c1 between two adjacent pixels in the first direction is (b*tan α4)/(p/2), and a difference between the fourth spacing d2 between two adjacent lenses in the second direction and the second spacing d1 between two adjacent pixels in the second direction is d1 (b*tan β4)/(q/2);
wherein α1, α2, α3, α4 are viewing angles at edges of the four areas of the backplane in the first direction, β1, β2, β3, β4 are viewing angles at edges of the four areas of the backplane in the second direction, b is a distance between the lens and the pixel in the direction perpendicular to the backplane, p is a resolution of the backplane in the first direction, and q is a resolution of the backplane in the second direction.

9. The display device according to claim 1, wherein a viewing angle difference between a left edge and a center of the display device is different from a viewing angle difference between a right edge and the center, the display device is divided into upper left area 1, upper right area 2, lower left area 3, and lower right area 4, with a different pixel spacing in each region,
in the area 1, the spacing c1 of the pixel in the first direction in the area 1 is adjusted to c2−(b*tan α1)/(p/2), and the spacing d1 of the pixel in the second direction in the area 1 is adjusted to d2−(b*tan β1)/(q/2),
in the area 2, the spacing c1 of the pixel in the first direction in the area 2 is adjusted to c2−(b*tan α2)/(p/2), and the spacing d1 of the pixel in the second direction in the area 2 is adjusted to d2−(b*tan β2)/(q/2),
in the area 3, the spacing c1 of the pixel in the first direction in the area 3 is adjusted to c2−(b*tan α3)/(p/2), and the spacing d1 of the pixel in the second direction in the area 3 is adjusted to d2−(b*tan β3)/(q/2),
in the area 4, the spacing c1 of the pixel in the first direction in the area 4 is adjusted to c2−(b*tan α4)/(p/2), and the spacing d1 of the pixel in the second direction in the area 4 is adjusted to d2−(b*tan β4)/(q/2).

10. The display device according to claim 1, a viewing angle difference between a left edge and a center of the display device is different from a viewing angle difference between a right edge and the center, the display device is divided into upper left area 1, upper right area 2, lower left area 3, and lower right area 4, with a different pixel spacing in each region,
in the area 1, the spacing c2 of the lens in the first direction in the area 1 is adjusted to c1+(b*tan α1)/(p/2), and the spacing d2 of the lens in the second direction in the area 1 is adjusted to d1+(b*tan β1)/(q/2),
in the area 2, the spacing c2 of the lens in the first direction in the area 2 is adjusted to c1+(b*tan α2)/(p/2), and the spacing d2 of the lens in the second direction in the area 2 is adjusted to d1+(b*tan β2)/(q/2),
in the area 3, the spacing c2 of the lens in the first direction in the area 3 is adjusted to c1+(b*tan α3)/(p/2), and the spacing d2 of the lens in the second direction in the area 3 is adjusted to d1+(b*tan β3)/(q/2),
in the area 4, the spacing c2 of the lens in the first direction in the area 4 is adjusted to c1+(b*tan α4)/(p/2), and the spacing d2 of the lens in the second direction in the area 4 is adjusted to d1+(b*tan β4)/(q/2).

11. A head-up display system, wherein the head-up display system comprises an optical assembly and a display device, the display device comprising:
a backplane provided with a plurality of pixels; and
a lens assembly disposed on the backplane, the lens assembly including a plurality of lenses, each lens being positioned over a corresponding one of the pixels;
wherein in a top view of the display device, a first spacing c1 between two adjacent pixels in a first direction is less than a second spacing d1 between two adjacent pixels in a second direction, and the second spacing d1 is less than or equal to 1.5 times the first spacing c1;
in the top view of the display device, a third spacing c2 between two adjacent lenses in the first direction is less than a fourth spacing d2 between two adjacent lenses in the second direction;
wherein the optical assembly is configured to magnify and output a picture displayed by the display device, and the optical assembly has a magnification of M in the first direction and a magnification of M/(d1/c1) in the second direction for the picture displayed by the display device.

12. The head-up display system according to claim 11, wherein the third spacing c2 is greater than or equal to the first spacing c1 and the fourth spacing d2 is greater than the second spacing d1.

13. The head-up display system according to claim 11, wherein a difference between the third spacing c2 and the first spacing c1 is (b*tan α)/(p/2), or a difference between the third spacing c2 and the first spacing c1 is 0;
a difference between the fourth spacing d2 and the second spacing d1 is (b*tan γ)/(q/2);
where b is a distance between the lens and the pixel in a direction perpendicular to the backplane, α is a viewing angle at an edge of the backplane in the first direction, p is a resolution of a display area of the display device in the first direction, γ is a viewing angle at an edge of the backplane in the second direction, and q is a resolution of a display area of the display device in the second direction.

14. The head-up display system according to claim 13, wherein under a condition that the third spacing c2 is greater than the first spacing c1, c1=c2−(b*tan α)/(p/2);
$$d 1 = d 2 - ( b * tan γ ) / ( q / 2 ) ;$$
where c2=l/p, d2=w/q, and l is a length value of the display area of the display device in the first direction, and w is a length value of the display area of the display device in the second direction.

15. The head-up display system according to claim 13, wherein under a condition that the third spacing c2 is greater than the first spacing c1, c2=c1+(b*tan α)/(p/2);
$$d 2 = d 1 + ( b * tan γ ) / ( q / 2 ) ;$$
where c1=l/p, d1=w/q, and l is a length value of the display area of the display device in the first direction, and w is a length value of the display area of the display device in the second direction.

16. The head-up display system according to claim 13, wherein in the top view of the display device, an offset value between a center of an m-th pixel and a center of an m-th lens in the first direction is (m*b*tan α)/(p/2), and an offset value between a center of an n-th pixel and a center of an n-th lens in the second direction is (n*b*tan γ)/(q/2);
wherein m is greater than or equal to 1 and less than p/2 and n is greater than or equal to 1 and less than q/2.

17. The head-up display system according to claim 11, wherein in the top view of the display device, in the first direction, an offset value between a center of the lens located at a center of the backplane and a center of the pixel located at the center of the backplane is 0, and in the second direction, an offset value between the center of the lens located at the center of the backplane and the center of the pixel located at the center of the backplane is b*tan β, wherein b is a distance between the lens and the pixel in a direction perpendicular to the backplane, and β is a viewing angle at the center of the backplane in the second direction.

18. The head-up display system according to claim 11, wherein the backplane includes at least four areas, the at least four of the areas including an upper left area, an upper right area, a lower left area, and a lower right area;
for the upper left area, a difference between the third spacing c2 between two adjacent lenses in the first direction and the first spacing c1 between two adjacent pixels in the first direction is (b*tan α1)/(p/2), and a difference between the fourth spacing d2 between two adjacent lenses in the second direction and the second spacing d1 between two adjacent pixels in the second direction is (b*tan β1)/(q/2);
for the upper right area, a difference between the third spacing c2 between two adjacent lenses in the first direction and the first spacing c1 between two adjacent pixels in the first direction is (b*tan α2)/(p/2), and a difference between the fourth spacing d2 between two adjacent lenses in the second direction and the second spacing d1 between two adjacent pixels in the second direction is (b*tan β2)/(q/2);
for the lower left area, a difference between the third spacing c2 between two adjacent lenses in the first direction and the first spacing c1 between two adjacent pixels in the first direction is (b*tan α3)/(p/2), and a difference between the fourth spacing d2 between two adjacent lenses in the second direction and the second spacing d1 between two adjacent pixels in the second direction is (b*tan β3)/(q/2);
for the lower right area, a difference between the third spacing c2 between two adjacent lenses in the first direction and the first spacing c1 between two adjacent pixels in the first direction is (b*tan α4)/(p/2), and a difference between the fourth spacing d2 between two adjacent lenses in the second direction and the second spacing d1 between two adjacent pixels in the second direction is d1 (b*tan β4)/(q/2);
wherein α1, α2, α3, α4 are viewing angles at edges of the four areas of the backplane in the first direction, β1, β2, β3, β4 are viewing angles at edges of the four areas of the backplane in the second direction, b is a distance between the lens and the pixel in the direction perpendicular to the backplane, p is a resolution of the backplane in the first direction, and q is a resolution of the backplane in the second direction.

19. An automobile, wherein the automobile includes a head-up display system including an optical assembly and a display device, the display device comprising:
a backplane provided with a plurality of pixels; and
a lens assembly disposed on the backplane, the lens assembly including a plurality of lenses, each lens being positioned over a corresponding one of the pixels;
wherein in a top view of the display device, a first spacing c1 between two adjacent pixels in a first direction is less than a second spacing d1 between two adjacent pixels in a second direction, and the second spacing d1 is less than or equal to 1.5 times the first spacing c1;
in the top view of the display device, a third spacing c2 between two adjacent lenses in the first direction is less than a fourth spacing d2 between two adjacent lenses in the second direction;
wherein the optical assembly is configured to magnify and output a picture displayed by the display device, and the optical assembly has a magnification of M in the first direction and a magnification of M/(d1/c1) in the second direction for the picture displayed by the display device.

20. The automobile of claim 19, wherein the backplane includes at least four areas, the at least four of the areas including an upper left area, an upper right area, a lower left area, and a lower right area;
for the upper left area, a difference between the third spacing c2 between two adjacent lenses in the first direction and the first spacing c1 between two adjacent pixels in the first direction is (b*tan α1)/(p/2), and a difference between the fourth spacing d2 between two adjacent lenses in the second direction and the second spacing d1 between two adjacent pixels in the second direction is (b*tan β1)/(q/2);
for the upper right area, a difference between the third spacing c2 between two adjacent lenses in the first direction and the first spacing c1 between two adjacent pixels in the first direction is (b*tan α2)/(p/2), and a difference between the fourth spacing d2 between two adjacent lenses in the second direction and the second spacing d1 between two adjacent pixels in the second direction is (b*tan β2)/(q/2);
for the lower left area, a difference between the third spacing c2 between two adjacent lenses in the first direction and the first spacing c1 between two adjacent pixels in the first direction is (b*tan α3)/(p/2), and a difference between the fourth spacing d2 between two adjacent lenses in the second direction and the second spacing d1 between two adjacent pixels in the second direction is (b*tan β3)/(q/2);
for the lower right area, a difference between the third spacing c2 between two adjacent lenses in the first direction and the first spacing c1 between two adjacent pixels in the first direction is (b*tan α4)/(p/2), and a difference between the fourth spacing d2 between two adjacent lenses in the second direction and the second spacing d1 between two adjacent pixels in the second direction is d1 (b*tan β4)/(q/2);
wherein α1, α2, α3, α4 are viewing angles at edges of the four areas of the backplane in the first direction, β1, β2, β3, β4 are viewing angles at edges of the four areas of the backplane in the second direction, b is a distance between the lens and the pixel in the direction perpendicular to the backplane, p is a resolution of the backplane in the first direction, and q is a resolution of the backplane in the second direction.
